(19) United States
(12) Patent Application Publication
(10) Pub. No.: US 2008/0091800 A1
(43) Pub. Date: Apr. 17, 2008

(54) Local user interface support of remote services

(75) Inventors: Daniel G. Sorrentino, Avon, NY (US); James C. Campbell, Fairport, NY (US); Ajay A. Amin, Rochester, NY (US); Michelle Bremner, Hilton, NY (US); Susan C Thibodeau, Fairport, NY (US); Suzanne M. Peebles, Pittsford, NY (US); Andrew M. Phelps, St. Albans (GB)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/801,029

(22) Filed: May 8, 2007

Related U.S. Application Data
(60) Provisional application No. 60/851,794, filed on Oct. 13, 2006.

(51) Int. Cl. G06F 15/16

(52) U.S. Cl. 709/219

(57) ABSTRACT

A multifunction device enables access to both services resident on the multifunction device (MFD) and remote services through a user interface that processes digital documents through use of a Web browser. The device includes a browser for requesting and viewing external web applications pages on the local user interface of the MFD for remote service(s) running in the browser and for transmitting system events to remote service browser page(s). The device also includes a local applications service, which controls services resident on the MFD, and a local user interface, which permits local and remote systems to interrogate and control the MFD. Web services provide application programming interface(s) capable of utilizing a plurality of web protocols.

### BACKGROUND AND SUMMARY

This disclosure relates generally to digital document processing within a networked environment, and more particularly to a system and method in which remote services are accessed on a local user interface of a device the processes digital documents through use of a Web browser.

In the area of digital printing and copying, there has been a growth in demand for multifunction electronic printing devices (MFD). Such devices may assume the form of an arrangement in which a single print engine (e.g., xerographic or thermal ink jet print engine) is coupled with a plurality of different image input devices (or “services”), with such devices being adapted to produce image related information for use by the printer or transmitted over a network. The image related information, in one example, could have its origin in video facsimile signals, microfilm, data processing information, light scanning platens for full size documents, aperture cards, and microfiche. MFDs provide a broader range of functionality than traditional single-function devices, such as dedicated printers, copiers, and scanners. Because of their network transmission capabilities combined with their functionality, it would be useful for MFDs to be able to utilize web browsers to access information from the World Wide Web and various document devices present on the LAN to which the MFD is connected.

One approach for providing the capability for MFDs to utilize web browsers is presented in U.S. Patent Application Publication 2006/0059462 to Yamamoto. Yamamoto utilizes Web 1.0 technology, in which web servers supply HTML (Hypertext Markup Language) document data using HTTP (Hypertext Transfer Protocol) and Web browsers, as clients, acquire the HTML document data using HTTP and display the acquired data. However, Web usage has increasing moved toward interaction and social networks, which can serve content that exploits network effects with or without creating a visual, interactive web page. This change in usage, informally described as Web 2.0, utilizes technologies such as Ajax (Asynchronous JavaScript and XML) and SOA (Service-Oriented Architecture) to allow greater flexibility and choice of access method. Ajax is a web development technique for creating interactive web applications that feel more responsive by exchanging small amounts of data with the server behind the scenes, so that the entire web page does not have to be reloaded each time the user makes a change. SOA expresses a perspective of software architecture that defines the use of loosely coupled software services to support the requirements of the business processes and software users. In an SOA environment, resources on a network are made available as independent services that can be accessed without knowledge of their underlying platform implementation.

It would be useful to have an interface on the MFD that utilizes Web 2.0 technologies such as AJAX and SOA to allow greater flexibility and choice of access method. The interface would enable a user implementing a web application to access MFD functions or other external SOA interfaces from their web server or from within the web application running on the browser. This would give the developer a potentially limitless supply of functionality from different devices and servers across their network or across the world wide web. The use of Web 2.0 technologies also allows dynamic content to be displayed in a single web application page. The browser could request information from the MFD using Web Services calls from within a single page and update the content of the page without having to re-visit the web application server.

All U.S. patents and published U.S. patent applications cited herein are fully incorporated by reference. The following patents or publications are noted.

U.S. Patent Application Publication No. 2006/0059462 to Yamamoto (“Embedded Device, Control Method Therefor, Program for Implementing the Control Method, and Storage Medium Storing the Program”) describes an embedded device incorporating a Web browser, which enables a server to provide a dynamic content adapted and linked to a function specific to the embedded device as an easily and flexibly expandable service in response to access from the embedded browser while enabling securing privacy and security of information on a client. In an image processing apparatus implementing the embedded device, a Web browser module loads Web content data containing document data which is described in a markup language and has a script or information for reference to a script embedded therein, and performs presentation based on the loaded Web content data. A controller unit controls information and operation of the image processing apparatus. A script interpreter incorporated in the Web browser module interprets the document data contained in the loaded Web content data and processes the script or the information for reference to a script embedded in the document data. A control API module provides an interface via which the script interpreter gains access, based on the processing of the script, to a DOM managed in the Web browser module. The control API module also provides an interface via which the script interpreter gains access, based on the processing of the script, to the information and operation of the embedded device, controlled by the controller unit.

U.S. Patent Application Publication No. 2006/0179413 to Eifler et al. (“System and Method of Accessing Dynamic Web Content from a Multifunction Printer Using Standard Protocols”) describes a system and method of accessing dynamic web content from a peripheral. The method includes the acts of providing a graphical user interface (GUI) on the peripheral, the GUI including a plurality of element selectable by a user, associating at least one element with a script configured to access dynamic web content when executed; detecting selection of the element; and presenting accessed dynamic web content to the user. The system and method are independent of a web browser or a personal computer.

The disclosed embodiments provide examples of improved solutions to the problems noted in the above Background discussion and the art cited therein. There is shown in these examples an improved multifunction device which enables access to both services resident on the multifunction device (MFD) and remote services through a user interface that processes digital documents through use of a Web browser. The device includes a browser for requesting and viewing external web applications pages on the local user interface of the MFD for remote service(s) running in the browser and for transmitting system events to remote service browser page(s). The device also includes a local applications service, which controls services resident on the MFD, and a local user interface, which permits local and remote systems to interrogate and control the MFD. Web services provide application programming interface(s) capable of utilizing a plurality of web protocols.

In an alternate embodiment there is disclosed a method for controlling a multifunction device in a networked environment to provide local user interface support for remote services. The networked environment includes a web service, an application service, at least one multifunction device, and a web browser. The method includes displaying a default local user interface screen having a selectable custom services option on the MFD and loading a local web page when the custom services option is selected. The local web page displays placeholders for each registered web application. The application's root page is retrieved when an operator selects the ‘example application’ placeholder appearing on the local web page. Documents to be scanned are received and a client identification number provided by the operator is received and verified. The documents are scanned and transmitted with the client identification number to the web application service. The scanned documents are placed into a client directory and storage of the documents is confirmed.

In yet another embodiment there is disclosed a computer-readable storage medium having computer readable program code embodied in the medium which, when the program code is executed by a computer, causes the computer to perform method steps for controlling a multifunction device in a networked environment to provide local user interface support for remote services. The networked environment includes a web service, an application service, at least one multifunction device, and a web browser. The method includes displaying a default local user interface screen having a selectable custom services option on the MFD and loading a local web page when the custom services option is selected. The local web page displays placeholders for each registered web application. The application's root page is retrieved when an operator selects the ‘example application’ placeholder appearing on the local web page. Documents to be scanned are received and a client identification number provided by the operator is received and verified. The documents are scanned and transmitted with the client identification number to the web application service. The scanned documents are placed into a client directory and storage of the documents is confirmed.

### BRIEF DESCRIPTION OF THE DRAWINGS

The foregoing and other features of the embodiments described herein will be apparent and easily understood from a further reading of the specification, claims and by reference to the accompanying drawings in which:

FIG. 1 is a schematic illustration of one embodiment of a system that provides local user interface support for remote services;

FIG. 2 is a diagram illustrating in more detail the features of one embodiment of a system that provides local user interface support for remote services;

FIG. 3 illustrates an embodiment of an MFD local user interface when a remote service has been selected;

FIG. 4 illustrates an example embodiment of an MFD local user interface presenting various on-device and remote services;

FIG. 5 is a diagram illustrating the flow of information among the modules of the system that provides local user interface support for remote services;

FIG. 6 is a diagram illustrating an example embodiment of remote service client running in the browser application components;

FIG. 7 is a diagram illustrating an example embodiment of multifunction device components utilized in providing local user interface support for remote services; and

FIG. 8 is a flow chart illustrating operation of the local user interface providing support for remote services.

### DETAILED DESCRIPTION

In the following detailed description, reference is made to the accompanying drawings, which form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the disclosure. The following detailed description is, therefore, not to be taken in a limiting sense.

The method and system for accessing remote services on a local user interface through use of a Web browser described herein provides a new MFD interface that utilizes Web 2.0 technologies such as AJAX and SOA to allow greater flexibility and choice of access. The operator implementing a web application can choose to access MFD functions or other external SOA interfaces from their web server or from within the web application running on the browser. Additional functionality can be accessed using the standard “Web Services” approach irrespective of the location of the functionality on the network. This gives the developer a potentially limitless supply of functionality from different devices and servers across their network or across the world wide web. To permit interface standardization, the use of proprietary interfaces has been limited. The use of Web 2.0 technologies also allows dynamic content to be displayed in a single web application page. The browser can request information from the MFD using Web Services calls from within a single page and update the content of the page without having to re-visit the web application server.

While for the purposes of explanation the method and system will be described as functioning within a network including various printing and communication devices, it will be appreciated by those skilled in the art that accessing remote services on a local user interface through use of a Web browser may be beneficially utilized in any communication environment which requires a secure hard copy of a facsimile confirmation. All such variations and modifications are fully contemplated by the scope of the specification and claims herein.

Various computing environments may incorporate capabilities for accessing remote services on a local user interface through use of a Web browser. The following discussion is intended to provide a brief, general description of suitable computing environments in which the method and system may be implemented. Although not required, the method and system will be described in the general context of computer-executable instructions, such as program modules, being executed by a single computer. Generally, program modules include routines, programs, objects, components, data structures, etc., that perform particular tasks or implement particular abstract data types. Moreover, those skilled in the art will appreciate that the method and system may be practiced with other computer system configurations, including hand-held devices, multi-processor systems, microprocessor-based or programmable consumer electronics, networked PCs, minicomputers, mainframe computers, and the like.

The method and system may also be practiced in distributed computing environments where tasks are performed by remote processing devices that are linked through a communication network. In a distributed computing environment, program modules may be located in both local and remote memory storage devices.

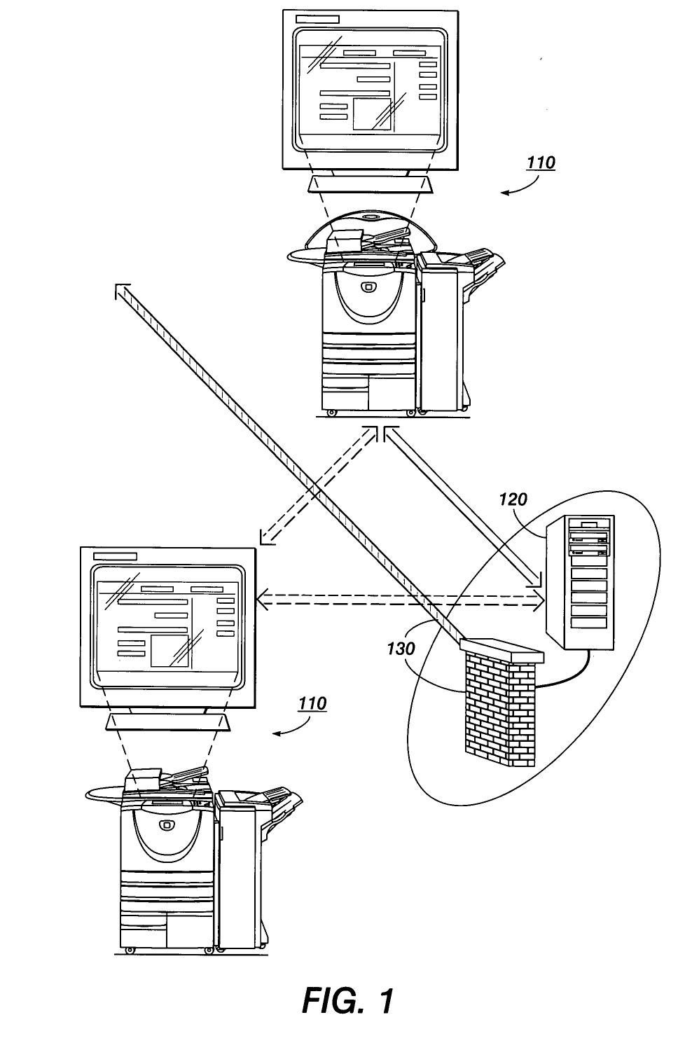

Referring to FIG. 1, the block diagram illustrates an example embodiment of a system that provides local user interface support for remote services, such as accounting packages, document repositories, billing applications, medical record services, etc. In other words, services that execute on computers external to the MFD, that are provided by companies other than Xerox, but do not exclude services provided by Xerox. The network environment may also contain various multifunction devices 110, an application server 120 for hosting remote services, and various other devices, such as personal computers, printer servers, printers, etc., all connected to network 130 with access to the internet. While for the purposes of brevity of description the method and system are described as utilizing a graphical user interface present on the multifunction device 110, such access may be accomplished by a user interacting with the MFD user interface and invoking a remote service at the local user interface.

The multifunction device 110 may be a standalone device or may form part of a network including various printer and copying devices. Multifunction device 110 may be any device capable of scanning image material. The scanned image may be in various formats, for example, but not limited to, PDF (portable document format), TIFF (tag image file format), JPEG (joint photographics experts group format), GIF (graphics interchange format), or BMP (BitMaP). In addition to scanning and transmitting the scanned image via electronic mail, multifunction device 110 may also include functionality for printing, copying, or transmitting facsimile images. Operation of multifunction device 110 is controlled from a user interface, which enables a user to select the function to be performed as well as enter information required by the device to perform an operation. Typically buttons or a keypad are utilized to enter information and select functionality, but a touch screen or any other means known in the art may be utilized. The user interface may be customized to reflect the document processing needs of the operator or the operators organization.

Additionally, third parties with preexisting solutions or third parties that can customize existing applications may be contacted through the interface. These remote service solutions may be in the form of software and hardware solutions to extend the base functionality of the multifunction device. The remote services solutions may be produced for specific customers or produced as generic products for any interested party. Application server 120 hosts the web applications that will appear on the local user interface of the multifunction device. The web applications hosted on the server 120 may be registered with several multifunction devices and accessed via the local user interfaces of those multifunction devices.

All these main components are coupled together via network 130. The system and method herein are not limited to a particular type of network system 130. Typical network interfaces include general-purpose systems such as POTS (plain-old telephone systems) and ISDN (Integrated Services Digital Network), as well as special-purpose systems such as a LAN (Local Area Network) or a WAN (Wide Area Network). Such networking environments are commonplace in offices, enterprise-wide computer networks, intranets and the Internet. Those skilled in the art will appreciate that the principles of the system and method described herein can be applied to virtually any network system without departing from the scope of the claims and specification.

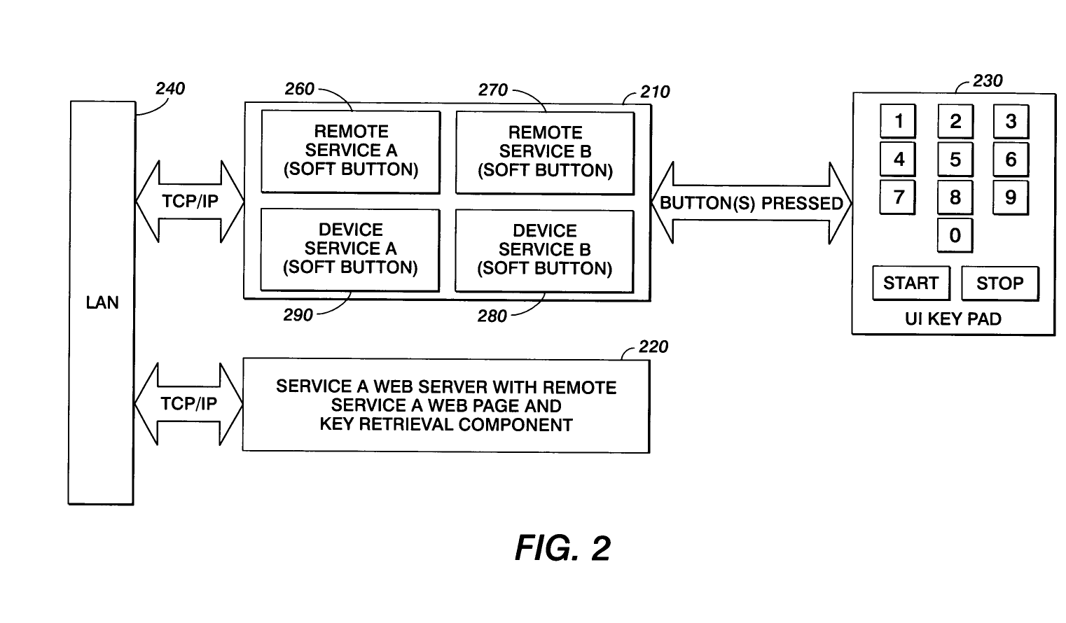

Turning now to FIG. 2, the communication among the devices for one embodiment of the system for providing local user interface support for remote services is described in more detail. One possible embodiment of an MFD user interface 210 provides access to various services which are resident on the MFD (On Device Service A 290 and On Device Service B 280), or which may be retrieved (Remote Service A 260 and Remote Service B 270) from a server 220 on the network 240. Server 220 responds to requests to upload remote services web pages, which include a key retrieval component. In the MFD user interface the remote services are network links in the form of Universal Resource Locators (URLs) to web pages located on remote service server(s). Both the On Device Services 280 and 290 and the Remote Services 260 and 270 appear as soft buttons on the MFD user interface. The user interface also provides communication with keypad 230, which includes number selection functionality 232 as well as start button 234 and stop button 236. Key presses from keypad 230 are captured and used by the web application in the same way as a desktop web application.

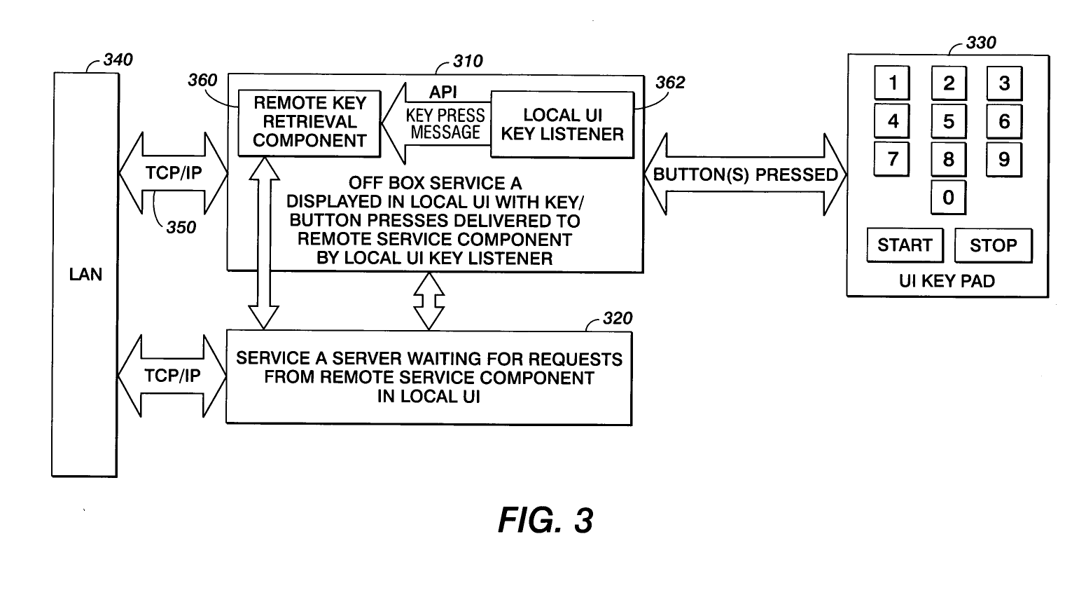

Referring now to FIG. 3, the MFD user interface display when a remote service has been selected is illustrated. When an operator selects a remote service, such as a Print Time Sheet or Print Prescription service, in the MFD user interface, a web browser is activated. The browser subsystem retrieves the web page with it remote key retrieval component from the server 320 and displays the remote service user interface in the MFD user interface display 310. The MFD user interface activates the Key/Button Listening Component 362 on behalf of the remote service as ready to deliver button/key press messages to the remote service Key Retrieval Component 360. The remote service component is free to communicate with services running on the remote services server 320. For example, the component may “ask” for all of the names and telephone numbers of customers in address list “10” as part of building a “Scan to Fax” job. The components 320 and 362 allow clients executing in the Local User Interface to integrate in the MFD more seamlessly by making the KeyPad look like a standard keyboard to these applications.

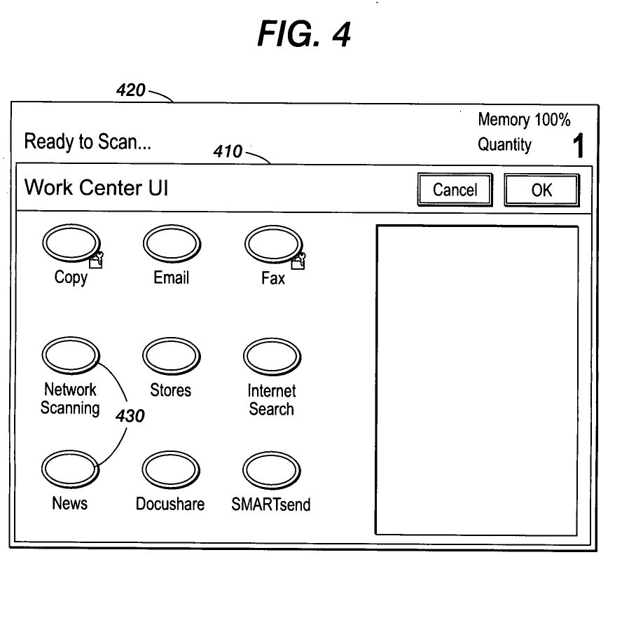

Turning now to FIG. 4, an example embodiment of a local user interface presenting the services available, both on device and remote, is illustrated. User interface 410 includes such on-device services as are commonly available on an MFD, such as copy, email, and facsimile capabilities 420. Also present are such remote services as RSS News, Network Scanning, and Google®Search 430.

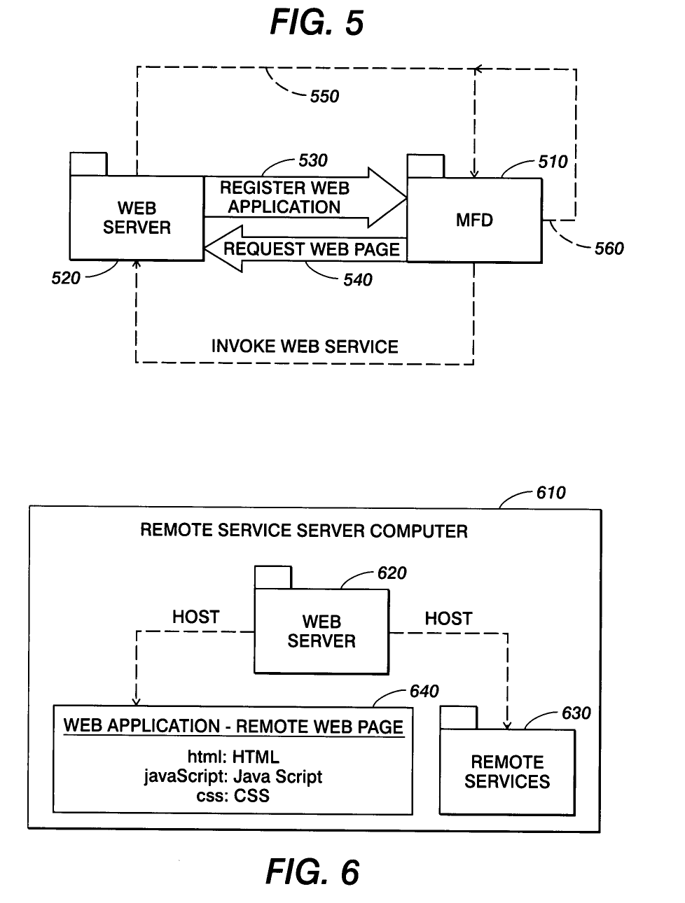

Turning now to FIG. 5, the flow of information among the various devices on the network is illustrated. Remote services applications are installed on a hosting computer 520 or may be deployed without becoming resident on the remote services server. The deployed application is registered (path 530) with the multifunction device 510 using any software registration tool known in the art. When this is accomplished, an operator may press a button linked to a registered remote service client running in the browser application and the multifunction device uses a web browser (path 540) to invoke the application by navigating to the initial page of the remote service application. Web services running on the multifunction device may be invoked by the remote service server (path 550), or by remote service pages executing in the multifunction device browser (path 560). Remote service pages executing in the multifunction device browser may invoke remote service web pages running on the remote service server (path 570).

Referring now to FIG. 6, the components of the remote service web applications are illustrated. Remote service applications are web applications that may be composed of HTML or XHTML pages, XML web services (e.g., Simple Object Access Protocol, a.k.a. S.O.A.P), asynchronous JavaScript and XML (AJAX), Java Applets, scripting languages, or any other type of content that runs in a Web Browser. The Web pages contain HTML or XHTML tags, css stylesheets (or references to external sheets), javascript, and graphic resources. These may invoke remote services of various types on the LAN or services resident in the MFD, such as authentication, scanning, faxing, copying, etc. These web pages and services are hosted via on a remote server. The remote service server 610 includes WebServer 620, application web pages 640, and remote services module 630. Application web pages 640 include remote service web pages developed using standard tools for web page development.

Each multifunction device may provide a set of widgets that can be utilized in creating pages of the device. The widgets enable a remote service to develop applications that have the same look and feel as the native device local user interface and reduce the cost of developing some functions like a soft keyboard. The widget set along with a set of Application Programming Interfaces (APIs) help to form a software development kit that is provided to the remote service client running in the browser.

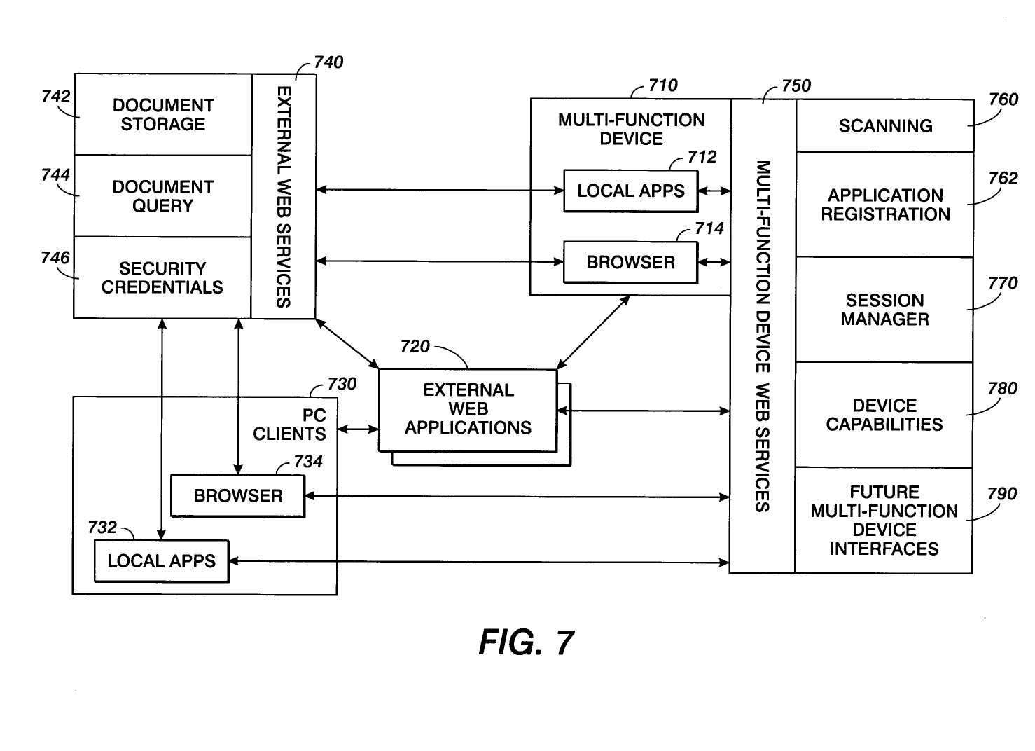

Referring to FIG. 7, an example embodiment of multifunction device components utilized in providing local user interface support for remote services is illustrated. Multifunction device 710 provides interfaces which are exposed using web services 750 to allow local and remote systems to interrogate and control the MFD. MFD 710 includes browser 714, which displays application pages on the local user interface of the multifunction device for the remote service client running in the browser and transmits system events to the remote service browser pages. System events can include notifications that content has arrived from a remote server, such as a phone list for faxing, an address book for scan-to-email, a list of accounts for selection. System events can also be notifications of the remote server being unavailable or that a local service (e.g., scanning) is not available. MFD 710 also includes local applications 712, such as copy, scan, fax, and diagnostics, among others.

MFD Web Services 750 are hosted by the MFD web server or an associated web service engine and may utilize AJAX, SOAP, HTTP, and HTTPS web protocols. These services may include, but are not limited to, application programming interfaces (APIs) such as scanning interface 760, application registration interface 762, session manager interface 770, device capabilities interface 780, and any additional interfaces 790 to be added as desired. Device capabilities API 780 provides, for example, accessibility to the MFD capabilities, which include information about the display, such as user interface display DPI (dots per inch), user interface display size, user interface display color depth, scan output formats, and user interface touchable areas, as well as various other features known in the art. Device Capabilities API 780 additionally provides the version of the user interface, browser properties, etc. Session management API 770 allows a remote operator to use the web service 750 to learn the credentials of the user who is logged onto the MFD. For example, session manager API 770 retrieves information about the currently logged-in user for security, personalization, and accounting purposes over HTTPS (shown as http(s)) and may be invoked only from the MFD. Application registration API 762 enables adding, removing, updating, deleting, and listing of the external web applications 720 accessible through the MFD browser. For example, it provides capability for registering web applications over http(s) and also supports deleting and changing previously registered applications for remote service clients running in the browser 714. The registration API 762 may be invoked from servers external to the MFD so that they can register their clients with the MFD for presentation in the MFD UI. Scanning API 760 allows a remote operator to access and control scanning on the MFD. This includes putting, getting, updating, deleting, and listing the device scan templates as well as initiating the scanning of a document to one of the scan templates.

External web services 740 reside on a server external to the MFD and include various services, such as document storage 742, database query 744, and security credentials 746, as well as other services known in the art. Document storage 742 provides networked document storage and retrieval capabilities and may include, for example, functions such as storing a scanned document, listing directories of documents, updating document details, listing document details, and retrieving a document, among others. Database query 744 provides data required by the application or provides offline storage of data the application generates. This data is dependent on the application being run but could include, for example, problem tracking records, timesheet data, customer contact details, user preferences and audit logs. Security credentials 746 returns the current logged in operator's credentials (i.e., username, email address, account codes etc.). PC 730 includes browser 734 and local applications 732. Any type of data, in the form of SOAP XML calls, may be exchanged among the various modules.

External web applications 720 may be requested and viewed through the MFD browser 714 as well as through PC browser 734. Information flowing between external web applications 72 and MFD web services 750 and external web services 740 includes HTML, JavaScript and Style sheets along with images and other data (for example, xml files, and data files).

The particular methods performed by the MFD in providing support for remote services comprise steps which are described below with reference to a series of flow charts. The flow charts illustrate an embodiment in which the methods constitute computer programs made up of computer-executable instructions. Describing the methods by reference to a flowchart enables one skilled in the art to develop software programs including such instructions to carry out the methods on computing systems. The language used to write such programs can be procedural, such as Fortran, or object based, such as C++. One skilled in the art will realize that variations or combinations of these steps can be made without departing from the scope of the disclosure herein.

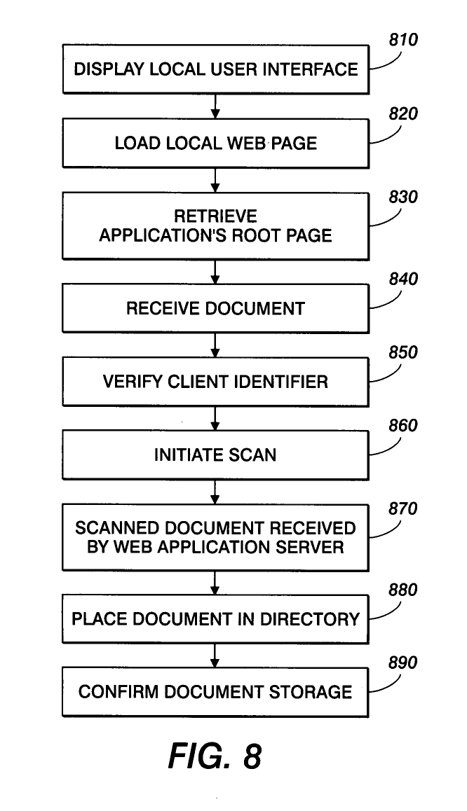

Turning now to FIG. 8, the flowchart illustrates operation of the MFD local user interface. At 810 the default local user interface screen, which may optionally be configurable, is displayed on the MFD. The optional configurable screen allows selection for the types of custom services and traditional services available to the operator. The types of custom services may include but are not limited to forms of authentication, accounting packages, document repositories, medical record services, and legal record services. The types of traditional services may include but are not limited to copying, faxing, scanning, and printing. The default local user interface screen includes a selectable option for custom services, which, when selected, causes the device to load a local web page at 820. The local web page displays placeholders for each of the registered web applications and may also display the available on-box services as well. An AJAX call is performed to retrieve the application's display title, and the operator is presented with a menu of registered applications. When the operator selects “example application” from the list of registered applications on the local user interface, the application's root page is retrieved from the web application server at 830 using HTTP or HTTPS. This page is rendered by the browser and displayed on the local user interface. For the purposes of illustrating operation of the user interface, the local application scanning is described. However, it is understood that any of the local services available on the MFD could be accessed.

At 840 the operator is prompted to place the document(s) they wish to scan into the document handler of the MFD. The operator is then prompted to enter a client identification number, which is verified at 850 by a client side script. For the purposes herein, client side script is defined as a script that is processed in the web browser (as opposed to a script that is processed on the web application server before returning a web page to the browser). In this case, there is a script defined in the loaded web page that validates the client identification number. When the scan is initiated at 860, the web application uses a client-side Web Services call to initiate the scan by connecting via HTTPS to the local MFD's Scanning Web Service. A response is returned from the web services including the scanning job ID. The client ID is returned to the web application server using an HTTP(S) POST command. The web application server receives the scanned document and the client ID at 870. At 880 the web application server uses the remote document repositories web service to push the document into the correct client directory. A page is generated by the web application server at 890 confirming the storage of the document. The operator is then returned to the local user interface.

While the present discussion has been illustrated and described with reference to specific embodiments, further modification and improvements will occur to those skilled in the art. Additionally, “code” as used herein, or “program” as used herein, is any plurality of binary values or any executable, interpreted or compiled code which can be used by a computer or execution device to perform a task. This code or program can be written in any one of several known computer languages. A “computer”, as used herein, can mean any device which stores, processes, routes, manipulates, or performs like operation on data. It is to be understood, therefore, that this disclosure is not limited to the particular forms illustrated and that it is intended in the appended claims to embrace all alternatives, modifications, and variations which do not depart from the spirit and scope of the embodiments described herein.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A multifunction device that enables access to both services resident on the multifunction device (MFD) and remote services through a user interface that processes digital documents through use of a Web browser, the device comprising:
browser for requesting and viewing external web applications pages on the local user interface of the MFD for at least one remote service running in the browser, and for transmitting system events to at least one remote service browser page, wherein said at least one remote service comprises at least one service not resident on the MFD;
local user interface for permitting local and remote systems to interrogate and control the MFD, wherein said local user interface is resident on the MFD;
local applications service for controlling services resident on the MFD, wherein said local applications service is accessed through said local user interface; and
web services providing at least one application programming interface capable of utilizing a plurality of web protocols, wherein said web services provides access to services that execute on computers external to the MFD, wherein said computers may be included within a local network or across the world wide web.

2. The multifunction device according to claim 1, wherein said at least on remote service includes at least one member selected from the group comprising accounting packages, document repositories, billing applications, and medical record services.

3. The multifunction device according to claim 1, wherein transmitting system events includes at least one member selected from the group comprising notification that content has arrived from said remote service, notification of said remote service being unavailable, and notification that a service resident on the MFD is unavailable.

4. The multifunction device according to claim 3, wherein said content from said remote service includes at least one member selected from the group comprising a telephone list for faxing applications, address book for scanning to email applications, and a list of accounts for account selection.

5. The multifunction device according to claim 1, wherein said at least one application programming interface includes at least one member selected from the group comprising a scanning interface, application registration interface, session manager interface, and device capabilities interface.

6. The multifunction device according to claim 5, wherein said scanning interface enables a remote operator to access and control the scanning function of the MFD.

7. The multifunction device according to claim 5, wherein said application registration interface provides the capability for registering at least one external Web application on the MFD and for changing or deleting previously registered external Web applications for remote service clients running in said browser.

8. The multifunction device according to claim 5, wherein said session manager interface permits a remote operator to learn the credentials of an operator logged onto the MFD.

9. The multifunction device according to claim 5, wherein said device capabilities interface provides accessibility to the MFD capabilities, wherein said MFD capabilities include at least one member selected from the group comprising the version of the user interface, properties of said browser, and information about the display.

10. The multifunction device according to claim 9, wherein said information about said display includes at least one member selected from the group comprising display dots per inch, display size, display color depth, scan output formats, and user touchable areas.

11. The multifunction device according to claim 1, wherein said at least one remote service includes at least one member selected from the group comprising document storage, database query, and security credentials.

12. The multifunction device according to claim 11, wherein said document storage service provides networked document storage and retrieval capabilities, including at least one member selected from the group comprising storing scanned documents, listing directories of documents, updating document datasets, listing document details, and retrieving documents.

13. The multifunction device according to claim 11, wherein said database query service provides data required by remote applications or offline storage of data the remote application generates, wherein said data includes at least one member selected from the group comprising problem tracking records, timesheet data, customer contact details, user preferences, and audit logs.

14. The multifunction device according to claim 11, wherein said security credentials service returns the current logged-in user's credentials, wherein said credentials include at least one member selected from the group comprising user name, email address, and account codes.

15. The multifunction device according to claim 1, wherein said external web applications communicate over a network with at least one member selected from the group comprising the MFD, at least one remote server, and at least one personal computer.

16. The multifunction device according to claim 15, wherein said external web applications are capable of being requested and viewed through either the MFD browser or said personal computer browser.

17. The multifunction device according to claim 15, wherein said external web applications may invoke services of various types available over said network or services resident in the MFD.

18. The multifunction device according to claim 15, wherein said external web applications are composed of at least one member selected from the group comprising HTML pages, XHTML pages, XML web services such as SOA protocol, AJAX, Java Applets, and scripting languages.

19. The multifunction device according to claim 1, wherein the MFD provides widgets to enable a remote service to develop applications that have the same look and feel as the MFD local user interface.

20. The multifunction device according to claim 1, wherein said web protocols include at least one member selected from the group comprising AJAX, SOA, HTTP, and HTTPS.

21. A method for controlling a multifunction device in a networked environment to provide local user interface support for remote services, wherein said local user interface is resident on the MFD, wherein the networked environment includes web services providing at least one application programming interface capable of utilizing a plurality of web protocols to provide access to services that execute on computers external to the MFD, a local applications service for controlling services resident on the MFD, with the local applications service accessed through the local user interface, at least one multifunction device, and a web browser, the method comprising:
displaying a default local user interface screen on the MFD, wherein said default local user interface screen includes a selectable custom services option;
loading a local web page when said custom services option is selected, wherein said local web page displays placeholders for each registered web application;
retrieving the application's root page when an operator selects the ‘example application’ placeholder appearing on said local web page;
receiving documents to be scanned;
receiving and verifying a client identification number provided by said operator;
initiating scanning;
transmitting said scanned documents and said client identification number to the web application service;
placing said scanned documents into a client directory; and
confirming storage of said documents.

22. A computer-readable storage medium having computer readable program code embodied in said medium which, when said program code is executed by a computer causes said computer to perform method steps for controlling a multifunction device in a networked environment to provide local user interface support for remote services, wherein said local user interface is resident on the MFD, wherein the networked environment includes web services providing at least one application programming interface capable of utilizing a plurality of web protocols to provide access to services that execute on computers external to the MFD, a local applications service for controlling services resident on the MFD, with the local applications service accessed through the local user interface, at least one multifunction device, and a web browser, the method comprising:
displaying a default local user interface screen on the MFD, wherein said default local user interface screen includes a selectable custom services option;
loading a local web page when said custom services option is selected, wherein said local web page displays placeholders for each registered web application;
retrieving the application's root page when an operator selects the ‘example application’ placeholder appearing on said local web page;
receiving documents to be scanned;
receiving and verifying a client identification number provided by said operator;
initiating scanning;
transmitting said scanned documents and said client identification number to the web application service;
placing said scanned documents into a client directory; and
confirming storage of said documents.
